(19) United States
(12) Patent Application Publication
(10) Pub. No.: US 2012/0127375 A1
(43) Pub. Date: May 24, 2012

(54) REMOTE CONTROL

(76) Inventor: William Frederick GEIER, White Stone, VA (US)

(21) Appl. No.: 12/949,255

(22) Filed: Nov. 18, 2010

(51) Int. Cl. H04N 5/44

(52) U.S. Cl. 348/734; 348/E05.096

(57) ABSTRACT

A remote control includes a top surface, a bottom housing connectable to the top surface, a plurality of protrusions extending outwardly from the top surface, a plurality of buttons associated with the plurality of protrusions such that pressure applied to the protrusions is transferred to the buttons to generate one or more actuation signals, and a transmitter connected to the buttons to receive the actuation signals and generate transmission signals. The transmission signals provide control instructions to a device associated with the remote control. The top surface includes an antimicrobial material, such as 3-Trimethoxy silyl propyl dimethyl octadecyl ammonium chloride.

### CROSS-REFERENCE TO RELATED PATENT APPLICATION(S)

This is a first-filed patent application and does not rely on any other patent application for priority.

### FIELD OF THE INVENTION

The present invention is directed to a remote control for electronic devices, specifically televisions. The present patent application provides a remote control with antimicrobial enhancements to minimize person-to-person transmission of various microbial irritants and diseases.

### DESCRIPTION OF THE RELATED ART

Remote controls for electronic devices have become ubiquitous in today's world.

Remote controls are used to control a large variety of electronic devices including televisions, stereos, cable boxes, lights, ceiling fans, and a seemingly limitless number of other devices.

Remote controls course may be handled successively by several individuals, which increases the potential for the transmission of microbial irritants and diseases from one person to another.

Remote controls typically present buttons and other types of control surfaces that are not easily cleaned. In addition, if a person were to attempt to clean a typical remote control with a liquid disinfectant, there is the possibility that the liquid might enter the housing for the remote control and interfere with the electronics within the remote control.

As a result, if a remote is used by a person infected with the common cold, for example, it is difficult (if not impossible) to disinfect the remote control prior to its use by a subsequent individual. As a result, remote controls can become vehicles for the transmission of microbial irritants and diseases from person to person.

While perhaps not a high level of concern for remote controls used in a private household with a few individuals, the level of concern is increased in instances where the remote control is available for use in a public environment, such as in a hotel or hospital room. In a hotel or hospital room, for example, it is possible for one guest/patient to transmit a microbial irritant or disease to several individuals who subsequently use the same remote control.

In view of this concern, there has developed a need for remote controls that help to reduce or eliminate transmission of microbial irritants and diseases from one person to the next.

U.S. Pat. No. 6,926,141 (hereinafter “the '141 patent”) provides one solution to the difficulties presented above. In the '141 patent, a flexible remote control hygienic enclosure 50 is described. (The '141 patent at col. 5, lines 17-22.) The enclosure 50 is essentially a flexible bag into which a specific remote control may be placed. The enclosure 50 may be sealed around the remote control such that it may be later opened to release the remote control. (The '141 patent at col. 5, lines 36-41.) The enclosure may include tamper evident features so that any attempt to open the enclosure is discoverable. (The '141 patent at col. 2, lines 24-25.) The enclosure also may be made from a material that exhibits antimicrobial properties, (The '141 patent at col. 2, lines 25-28.)

Other deficiencies with remote controls, in the context of the present invention, should be apparent to those skilled in the art.

### SUMMARY OF THE INVENTION

The present invention seeks to address one or more deficiencies in the prior art by providing a remote control that at least minimizes the transmission of microbial irritants and diseases from one person to the next.

It is, therefore, one aspect of the present invention to provide a remote control with a top surface and a bottom housing connectable to the top surface. A plurality of protrusions extends outwardly from the top surface. A plurality of buttons is associated with the plurality of protrusions such that pressure applied to the protrusions is transferred to the buttons to generate one or more actuation signals. A transmitter is connected to the buttons to receive the actuation signals and generate transmission signals. The transmission signals provide control instructions to a device associated with the remote control. At least the top surface includes an antimicrobial material.

In one contemplated embodiment, the top surface is a unitary sheet to which the antimicrobial material is affixed.

The top surface may be made from a material such as plastic, thermoplastic, and polytetrafluoroethylene.

The antimicrobial material may be one of microbicides, bacteristatics, bactericides, antimycotics, fungistatics, fungicides, viricides, and algicides.

It is contemplated that the antimicrobial material may be one of fatty alcohol sulphates, alklaryl sulphonates, quarternary ammonium connections, benzalconium chloride, halogen phenols, halogen salicylic anilides, phenolmercuriacetate a.s.o., phenylmercury acetate, silane-based materials, silver, silver-containing compounds, copper, copper-containing compounds, halides, halide-containing compounds, sulfonamides, and sulphur-containing compounds.

One specific embodiment contemplates that the antimicrobial agent is 3-Trimethoxy silyl propyl dimethyl octadecyl ammonium chloride.

Still further, the present invention contemplates a remote control where the top surface includes a substrate and an antimicrobial layer disposed on the substrate.

The remote control of the present invention is contemplated to be associated with at least one electronic device. Without limiting the invention, the electronic device may be associated with televisions, stereos, cable boxes, lights, ceiling fans, digital video disk recorders and players, and video cassette recorders.

In one contemplated embodiment, the substrate on the remote control excludes areas where microbes may collect or incubate.

It is also contemplated that the bottom housing may include an antimicrobial material, as discussed above.

Alternatively, the bottom housing may include a substrate and an antimicrobial layer disposed on the substrate.

Further aspects of the invention will become apparent from the discussion that follows.

### BRIEF DESCRIPTION OF THE DRAWINGS

The drawings appended hereto are intended to assist in the discussion of the invention and are not intended to be limiting of the invention. Where appropriate, like reference numerals refer to like structures and components, in which:

FIG. 1 is a top view of one contemplated embodiment of the remote control of the present invention;

FIG. 2 is a side view of the remote control illustrated in FIG. 1;

FIG. 3 is a bottom view of the remote control illustrated in FIG. 1; and

FIG. 4 is a schematic, cross-sectional side view of aspects of the remote control illustrated in FIG. 1.

Other aspects of the present invention should be appreciated from the drawings appended hereto.

### DESCRIPTION OF PREFERRED EMBODIMENT(S) OF THE INVENTION

The remote control of the present invention is intended for use with televisions, primarily. It is noted, however, that the present invention may be employed in connection with any type of remote control, regardless of the device to which the remote provides control signals. While specific embodiments of the invention will be described herein, the embodiments are meant to be illustrative only and are not meant to be limiting of the scope of the invention. To the contrary, those skilled in the art will appreciate variations and equivalents of the marine barrier system. Those variations and equivalents are intended to be encompassed by the present invention, even if not explicitly described herein.

As noted above, the present invention concerns a remote control for any type of device including, but not limited to, televisions, stereos, cable boxes, lights, ceiling fans, digital video disk (“DVD”) recorders and players, video cassette recorders (“VCRs”), and a seemingly limitless number of other devices. The identification of any particular device in the discussion that follows is not intended to be limiting of the present invention.

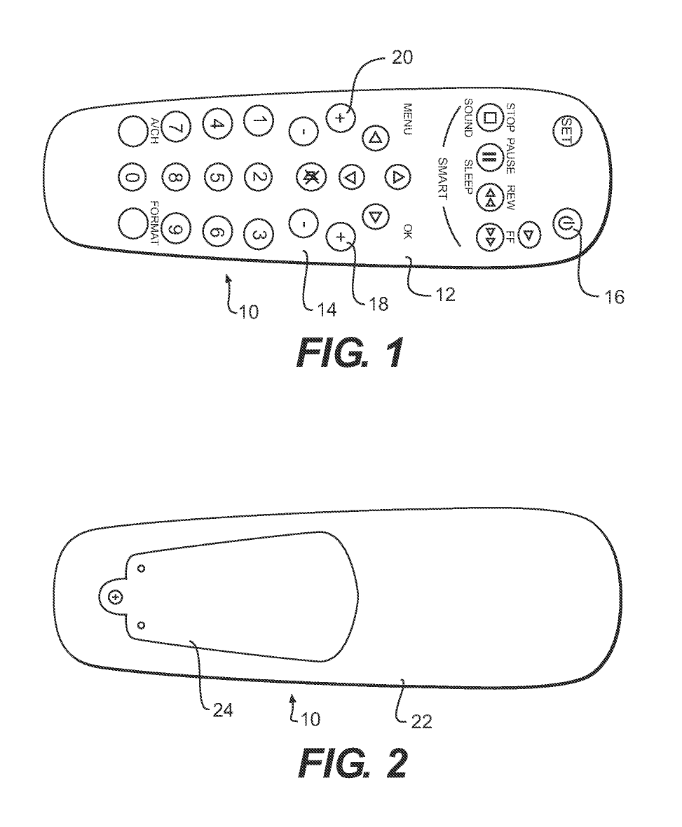

FIG. 1 is a top view of one contemplated embodiment of the remote control 10 of the present invention. The remote control 10 includes a body 12 defining a top surface 14. One or more control buttons 16 are provided on the top surface 14.

The buttons 16 that are depicted in FIG. 1 are intended to be representative of the type of buttons 16 that may be incorporated into the top surface 14 of the remote control 10. The buttons 16 that are illustrated are typical for what has become known as a “universal” remote control, which is intended to operate a television, a cable box, and at least one electronic media player, such as a DVD or VCR. As should be apparent to those skilled in the art, any number of buttons 16 may be included on the remote control 10 without departing from the scope of the present invention.

In the illustrated embodiment, the buttons 16 are convex protrusions 18 (or humps) that extend upwardly from the top surface of the body 12 of the remote control 10, FIG. 4, which is discussed in greater detail below, illustrates this aspect of the remote control 10 of the present invention in greater detail.

In an alternative, it is contemplated that the top surface 14 of the remote control 10 may be entirely flat, meaning that it does not present any raised areas 18 for individual buttons 16. However, it is believed that most individuals respond more favorably to a tactile surface rather than a flat surface. Accordingly, the present invention contemplates the incorporation of convex protrusions 18 for the remote control 10.

In an embodiment that is not illustrated herein, it is contemplated that the top surface 14 of the remote control might include concave indentations at the locations of the buttons 16. Whether the top surface 14 includes convex protrusions 18, convex indentations, or a flat surface, the top surface will include functional indicia 20 that indicate the functionality of the buttons 16 that underlie the top surface 14. Accordingly, for purposes of the discussion herein, the term functional indicia 20 will be used to indicate the portion of the top surface 14 that corresponds to the electronic switches that comprise the buttons 16.

With respect to the embodiment illustrated in FIG. 1, it is noted that the convex protrusions 18 are circular in shape. While this has been selected for the illustrated embodiment, it is contemplated that the convex protrusions 18 may take any suitable shape, as should be understood by those skilled in the art.

FIG. 2 provides a bottom view of the remote control 10 of the present invention. The bottom housing 22 includes an openable panel 24 that permits access to a battery compartment therein.

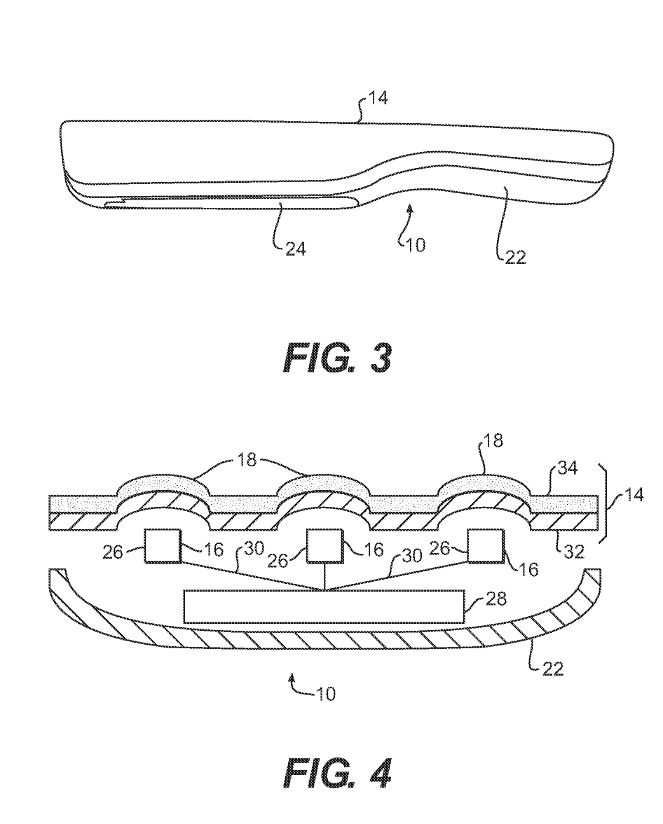

FIG. 3 is a side view of the remote control 10 of the present invention. The side view is presented to provide a general understanding of the shape of the remote control 10. It is noted, however, that the shape of the remote control 10 is not critical to present invention. To the contrary, any suitable shape may be employed without departing from the scope of the present invention.

FIG. 4 is a side-view, schematic, cross-sectional illustration of the remote control 10 of the present invention. As illustrated, the top surface 14 is intended to mate with the bottom housing 22 to form the body 12 of the remote control. The convex protrusions 18, consistent with the embodiment illustrated in FIG. 1, are visible in this illustration. Also visible are the electronic switches 26 that form part of the buttons 16, it being understood that the functional indicia 20 also are associated with the buttons 16. The switches 26 are connected to electronics 28 via communication lines 30.

The top surface 14 of the remote control 10 is now described in greater detail. Specifically, the top surface 14 includes a substrate 32 and an antimicrobial coating 34. The details of the substrate 32 and the coating 34 are discussed in greater detail below. It is noted, however, that the top surface 14 need not be constructed of two layers. To the contrary, a larger number of layers may be employed without departing from the scope of the present invention. In addition, it is contemplated that a single layer may be employed for the top surface 14, if the single layer provides antimicrobial characteristics.

The substrate 32 is contemplated to be selected from any number of materials that include, but are not limited to, plastics, thermoplastics, composite materials, metals, metal alloys, etc. In the illustrated embodiment, the substrate 32 is a layer of polytetrafluoroethylene (“PET”). Of course, as indicated, any suitable material may be employed that provides sufficient flexibility to activate the electronic switches 26.

As should be apparent from FIG. 4, the substrate 32 is contemplated to be a unitary sheet of material that covers the entire upper side of the remote control 10 to form the upper surface 14 thereof. As a single sheet, the substrate presents a smooth surface that minimizes or eliminates any cracks, crevices, or other areas that might be prone to trap microbial irritants and organisms and, thereby, provide areas for retention of the same. The substrate 32, therefore, is anticipated to be fashioned as a single sheet. Of course, the substrate may be manufactured from different parts, if required or desired.

in one contemplated embodiment, the substrate 32 is a layer of PET that is 0.12 mm thick. Preferably, the substrate 32 is transparent. However, transparency is not required to practice the present invention. Where a transparent substrate 32 is used, the functional indicia 20 are printed onto the bottom surface of the substrate 32. As a result, the functional indicia 20 cannot be removed or rubbed off by the user(s) over an extended period of time. Alternatively, it is contemplated that the functional indicia 20 may be printed onto the top surface of the substrate 32. If so, it is contemplated that a protective layer of plastic (or other suitable material) may be laid thereover to protect the functional indicia 20 from wear.

The antimicrobial coating 34 may incorporate any number of different antimicrobial agents. As a precursor, it is noted that antimicrobial agents encompass a wide variety of materials. Antimicrobial materials encompass microbicides, which refer to substances that are detrimental to organisms such as bacteria, fungii, or algae. Antimicrobial agents also encompass bacteristatics (materials that inhibit bacterial growth), bactericides (materials that kill bacteria), antimycotics (which include fungistatics and fungicides), and algicides (materials that kill algae). Antimicrobial materials also are understood to include viricides, which are materials that kill viral organisms.

Many of these materials rely on one or more active agents that include, but are not limited to, fatty alcohol sulphates, alkylaryl sulphonates, quarternary ammonium connections, benzalconium chloride, halogen phenols, halogen salicylic anilides, phenolmercuriacetate a.s.o., phenylmercury acetate, silane-based materials, silver, silver-containing compounds, copper, copper-containing compounds, halides, halide-containing compounds, sulfonamides, sulphur-containing compounds, and the like.

in the embodiment illustrated in FIG. 1, the antimicrobial agent selected was a silane-based material. Specifically, the antimicrobial agent has the chemical name 3-Trimethoxy silyl propyl dimethyl octadecyl ammonium chloride, and is manufactured by AEGIS, Inc., of Midland, Mich. The antimicrobial agent was mixed with water and isopropyl alcohol (“IPA”) in a predetermined, exact ratio to form a solution. The solution was then permitted to “incubate” for a period of two (2) days or more. After the solution incubated for a predetermined period of time, the solution was sprayed onto the top surface of the substrate 32 and was permitted to “cure” for a period of about two (2) weeks. The curing period permitted the antimicrobial agent to establish itself on the substrate 32 such that the antimicrobial agent became secured to the substrate and also became active.

With respect to the use of 3-Trimethoxy silyl propyl dimethyl octadecyl ammonium chloride as the antimicrobial agent, the agent was applied in a concentration of 25 mg/ft². While this is the exemplary concentration, it is understood that the concentration may be higher or lower without departing from the scope of the present invention.

As noted above, once applied to the substrate 32, the solution containing antimicrobial agent (3-Trimethoxy silyl propyl dimethyl octadecyl ammonium chloride) cures over a period of time of about two (2) weeks. This permits the antimicrobial agent to properly bond itself to the substrate in the proper molecular orientation, among other things, so that the antimicrobial agent is active. At ambient temperature and conditions, the curing process is about two (2) weeks. The curing process, however, may be accelerated to encompass just a few days, if a heat of 140° C. is applied during the curing process. It is noted that, after the solution is applied, the substrate 32 become dry relatively quickly after the spraying operation. The effectiveness of the antimicrobial agent, however, is not established until an appropriate amount of curing time has passed and the antimicrobial agent is properly bonded onto the substrate.

Once cured, the 3-Trimethoxy silyl propyl dimethyl octadecyl ammonium chloride does not wash off of the substrate nor does it wear off over time, at least not in any appreciable amounts. As a result, the antimicrobial agent is anticipated to retain its efficacy over time. The antimicrobial agent, for all intents and purposes, retains its original antimicrobial strength over the lifetime of the substrate.

As detailed by the manufacturer of 3-Trimethoxy silyl propyl dimethyl octadecyl ammonium chloride, the antimicrobial agent ruptures the microbial membrane or electrocutes the microbe (such as a bacterium) due to different electrical charges present at the microscopic level. As should be apparent, however, the present invention is not limited to antimicrobial agents that operate in this fashion.

As should be apparent to those skilled in the art, and as noted above, while 3-Trimethoxy silyl propyl dimethyl octadecyl ammonium chloride is described herein, the present invention is not limited to this material. Other materials may be employed without departing from the scope of the present invention.

Concerning the remote control 10, it is further noted that 3-Trimethoxy silyl propyl dimethyl octadecyl ammonium chloride may be applied to the bottom housing 22 so that the entirety of the remote control 10 presents an antimicrobial surface. As should be apparent, however, the same antimicrobial agent need not be applied to the top surface 14 and the bottom housing 22. To the contrary, different antimicrobial agents may be applied without departing from the scope of the present invention.

It is contemplated that the bottom housing 22, for example, may be manufactured from an antimicrobial plastic, composite, metal, or the like. If so, the bottom housing 22, as illustrated in FIG. 4, will not include an antimicrobial coating.

In still one further contemplated embodiment, the bottom housing 22 may be made from a conventional material. A substrate, like the substrate 32, may be affixed to the exterior surface of the bottom housing 22. An antimicrobial coating, like the antimicrobial coating 34, may be applied to the substrate affixed to the bottom housing 22. Other variations also are contemplated to fall within the scope of the present invention, as should be apparent to those skilled in the art.

The electronics 28 within the remote control 10 are configured to receive input signals from the switches 26 (that are part of the buttons 16) and transmit signals to the receiving device, such as a television. The buttons may incorporate piezoelectric switches (for the switches 26) that generate actuation signals when the buttons 16 are depressed. Those signals, in turn, are converted by the electronics 28 into signals that are transmitted to the associated electronic device.

The transmitted signals may be infrared (which is a common variety) or any other suitable part of the electromagnetic spectrum. The signals, for example, may be radio waves. It is also contemplated that the signals may be sound signals. In other words, the remote control 10 of the present invention is not limited to any particular type of transmission signal, as should be appreciated by those skilled in the art.

While the remote control of the present invention has been described in connection with specific embodiments thereof, the present invention is not intended to be limited solely to the embodiments described. As will be appreciated by those skilled in the art, elements of the invention may be altered from the specifics discussed above without departing from the scope and spirit of the invention. Moreover, it is intended that all equivalents that will be appreciated by those skilled in the art also fall within the scope of the present invention as discussed above and as recited by the claims appended hereto.

What is claimed is:

1. A remote control, comprising:
a top surface;
a bottom housing connectable to the top surface;
a plurality of protrusions extending outwardly from the top surface;
a plurality of buttons associated with the plurality of protrusions such that pressure applied to the protrusions is transferred to the buttons to generate one or more actuation signals;
a transmitter connected to the buttons to receive the actuation signals and generate transmission signals, the transmission signals providing control instructions to a device associated with the remote control,
wherein at least the top surface comprises an antimicrobial material.

2. The remote control of claim 1, wherein the top surface is a unitary sheet to which the antimicrobial material is affixed.

3. The remote control of claim 1, wherein the top surface comprises a material selected from a group comprising plastic, thermoplastic, and polytetrafluoroethylene.

4. The remote control of claim 1, wherein the top surface comprises polytetrafluoroethylene.

5. The remote control of claim 1, wherein the antimicrobial material comprises at least one selected from a group comprising microbicides, bacteristatics, bactericides, antimycotics, fungistatics, fungicides, viricides, and algicides.

6. The remote control of claim 1, wherein the antimicrobial material is selected from a group comprising fatty alcohol sulphates, alkylaryl sulphonates, quarternary ammonium connections, benzalconium chloride, halogen phenols, halogen salicylic anilides, phenolmercuriacetate a.s.o., phenylmercury acetate, silane-based materials, silver, silver-containing compounds, copper, copper-containing compounds, halides, halide-containing compounds, sulfonamides, and sulphur-containing compounds.

7. The remote control of claim 1, wherein the antimicrobial agent comprises 3-Trimethoxy silyl propyl dimethyl octadecyl ammonium chloride.

8. The remote control of claim 1, wherein the top surface comprises:
a substrate; and
an antimicrobial layer disposed on the substrate.

9. The remote control of claim 1, wherein the remote control is associated with at least one electronic device.

10. The remote control of claim 9, wherein the electronic device is selected from a group comprising televisions, stereos, cable boxes, lights, ceiling fans, digital video disk recorders and players, and video cassette recorders.

11. The remote control of claim 1, wherein the substrate excludes areas thereon where microbes may collect or incubate.

12. The remote control of claim 1, wherein the bottom housing comprises an antimicrobial material.

13. The remote control of claim 12, wherein the antimicrobial material comprises at least one selected from a group comprising microbicides, bacteristatics, bactericides, antimycotics, fungistatics, fungicides, viricides, and algicides.

14. The remote control of claim 12, wherein the antimicrobial material is selected from a group comprising fatty alcohol sulphates, alkylaryl sulphonates, quarternary ammonium connections, benzalconium chloride, halogen phenols, halogen salicylic anilides, phenolmercuriacetate a.s.o., phenylmercury acetate, silane-based materials, silver, silver-containing compounds, copper, copper-containing compounds, halides, halide-containing compounds, sulfonamides, and sulphur-containing compounds.

15. The remote control of claim 12, wherein the antimicrobial agent comprises 3-Trimethoxy silyl propyl dimethyl octadecyl ammonium chloride.

16. The remote control of claim 1, wherein the bottom housing comprises:
a substrate; and
an antimicrobial layer disposed on the substrate.

17. The remote control of claim 16, wherein the antimicrobial material comprises at least one selected from a group comprising microbicides, bacteristatics, bactericides, antimycotics, fungistatics, fungicides, viricides, and algicides.

18. The remote control of claim 16, wherein the antimicrobial material is selected from a group comprising fatty alcohol sulphates, alkylaryl sulphonates, quarternary ammonium connections, benzalconium chloride, halogen phenols, halogen salicylic anilides, phenolmercuriacetate a.s.o., phenylmercury acetate, silane-based materials, silver, silver-containing compounds, copper, copper-containing compounds, halides, halide-containing compounds, sulfonamides, and sulphur-containing compounds.

19. The remote control of claim 16, wherein the antimicrobial agent comprises 3-Trimethoxy silyl propyl dimethyl octadecyl ammonium chloride.
